(19) United States
(12) Patent Application Publication
(10) Pub. No.: US 2010/0085893 A1
(43) Pub. Date: Apr. 8, 2010

(54) SENSOR NODES IN MULTIPLE SENSOR NETWORK, METHOD FOR CREATING GRID-BASED TREE OF SENSOR NODES AND SPATIAL QUERY PROCESSING SYSTEM USING GRID-BASED TREE

(75) Inventors: Min Soo Kim, Daejeon (KR); In Sung Jang, Daejeon (KR); Ju Wan Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/424,146

(22) Filed: Apr. 15, 2009

(30) Foreign Application Priority Data
Oct. 7, 2008 (KR) 10-2008-0066991

(51) Int. Cl. H04L 12/28; G06F 17/30

(52) U.S. Cl. 370/254; 707/E17.014

(57) ABSTRACT

A method for creating a grid-based tree in a multiple sensor network includes: dividing an entire area in which a base station node and a plurality of sensor nodes are disposed into grid areas; assigning a grid ID to each of the grid areas; setting, sequentially from the base station node to each of the sensor node, level information, candidate child nodes and candidate parent nodes; storing a grid ID of a grid area in which the respective nodes locate; selecting, for the respective sensor nodes, a parent node based on the grid ID, the level information, and the candidate parent nodes; and calculating, for the respective nodes, minimum bounding rectangles each of which includes a child node of corresponding node and nodes descended from the child node. The grid-based tree is calculated by using the minimum bounding rectangles.

### CROSS-REFERENCE(S) TO RELATED APPLICATION(S)

The present invention claims priority of Korean Patent Application No. 10-2008-0066991, filed on Jul. 10, 2008, which is incorporated herein by reference.

### FIELD OF THE INVENTION

The present invention relates to a spatial join in a multiple sensor network; and, more particularly, to sensor nodes in a multiple sensor network, a method for creating a grid-based tree of the sensor nodes for a spatial search and a spatial query processing system using the grid-based tree.

### BACKGROUND OF THE INVENTION

The most representative technology relating to a spatial join in a multiple sensor network is a spatial search in a sensor network. A spatial search in a sensor network is to find specific sensor nodes within given spatial search areas by using a distributed spatial indexing method, while minimizing the number of wireless communication times among sensor nodes in the network.

For example, when fifteen spatial search areas S1 to S15 are given to a multiple sensor network having a base station and sensor nodes as shown in FIG. 1, information on the spatial search areas S1 to S15 needs to be delivered to the respective sensor nodes via wireless communications thereamong in order to perform spatial search in the network. At this time, due to a limitation of a wireless communications packet size in the sensor network, the information on the fifteen spatial search areas S1 to S15 cannot be transmitted in a single packet, but instead, the information on spatial search areas is divided to be transmitted in two or three packets in conventional spatial search methods. However, such conventional spatial search methods results in drastic increase in the number of wireless communication times, and thus cannot be applied to a spatial join in a sensor network having a large number of spatial search areas.

### SUMMARY OF THE INVENTION

In view of the above, the present invention provides sensor nodes in a multiple sensor network, a method for creating a grid-based tree of the sensor nodes for a spatial search and a spatial query processing system using the grid-based tree, in which, information on spatial search areas is transmitted in a single wireless communications packet by reducing a size of the information, and the number of wireless communication times among the sensor nodes is minimized by using a grid-based tree in the spatial search.

In accordance with a first aspect of the invention, there is provided a method for creating a grid-based tree in a multiple sensor network, the method including:

dividing an entire search area in which a base station node and a plurality of sensor nodes are disposed into a specific number of grid areas;

assigning a grid ID to each of the grid areas;

setting, sequentially from the base station node to each of the sensor node, level information, candidate child nodes and candidate parent nodes, and storing the same in the respective nodes;

storing, in the respective nodes, a grid ID of a grid area in which the respective nodes locate;

selecting, for the respective sensor nodes, a parent node based on the grid ID, the level information, and the candidate parent nodes stored in respective sensor nodes;

calculating, for the respective nodes, minimum bounding rectangles each of which includes a child node of corresponding node and nodes descended from the child node, and storing the minimum bounding rectangles in the respective nodes; and

creating the grid-based tree by using the minimum bounding rectangles.

In accordance with a second aspect of the invention, there is provided a spatial query processing system in a multiple sensor network, wherein an entire search area of the network includes a plurality of sensor networks each having a plurality of nodes and is divided into grid areas having different grid IDs, the system including:

a query analyzing unit for analyzing an input query to divide the input query into queries to be transmitted to the respective sensor networks, the queries including a query relating to a spatial search and a query not relating to the spatial search;

a query processing unit for receiving a query result data of the query not relating to the spatial search and changing, based on the received query result data, a spatial condition in the query related to the spatial search; and

a query transmitting unit for transmitting to the respective sensor networks the query received from the query analyzing unit and the query changed by the query processing unit.

In accordance with a third aspect of the invention, there is provided sensor nodes in a multiple sensor network, wherein an entire search area including a plurality of sensor networks is divided into grid areas having different grid IDs, each of the sensor nodes including:

a spatial search unit for receiving a query containing grid IDs as a spatial condition and performing a spatial search based on the grid IDs;

a query processing unit for processing the query based on a spatial search result of the spatial search unit; and

a result collection unit for collecting result data of the query processing unit,

wherein the sensor nodes are connected in a Grid-based tree structure, and, each of the sensor nodes stores therein a grid ID of a grid in which the sensor node locates, level information of the sensor node, information on child nodes and a parent node of the sensor node and a minimum bounding rectangle for each of the child nodes, each minimum bounding rectangle including one of the child nodes and nodes descended from the child node.

According to the present invention, a complex spatial join query in a multiple sensor network can be processed with a minimized number of communication times among nodes, which necessarily occurs during a spatial search process, by performing a grid ID-based spatial search using a grid-based tree.

Furthermore, the minimized number of wireless communication times results in reduction of power consumption in the respective nodes, thereby increasing lifespan of the battery-driven nodes.

### BRIEF DESCRIPTION OF THE DRAWINGS

The above features of the present invention will become apparent from the following description of embodiments, given in conjunction with the accompanying drawings, in which:

FIG. 1 illustrates an exemplary multiple sensor network for explaining a conventional spatial search method;

FIG. 2 illustrates an exemplary view for explaining method for creating a Grid-based tree in accordance with an embodiment of the present invention;

FIG. 3 illustrates an exemplary view for explaining parent node selection process during creating the Grid-based tree;

FIG. 4 illustrates an exemplary view for explaining MBR calculation process performed in each sensor node;

FIG. 5 illustrates an exemplary grid-based tree created in accordance with the present invention;

FIG. 6 illustrates a block diagram of a system for processing a complex spatial join query for two heterogeneous sensor networks; and

FIGS. 7A to 7C illustrate exemplary views for explaining a query processing procedure.

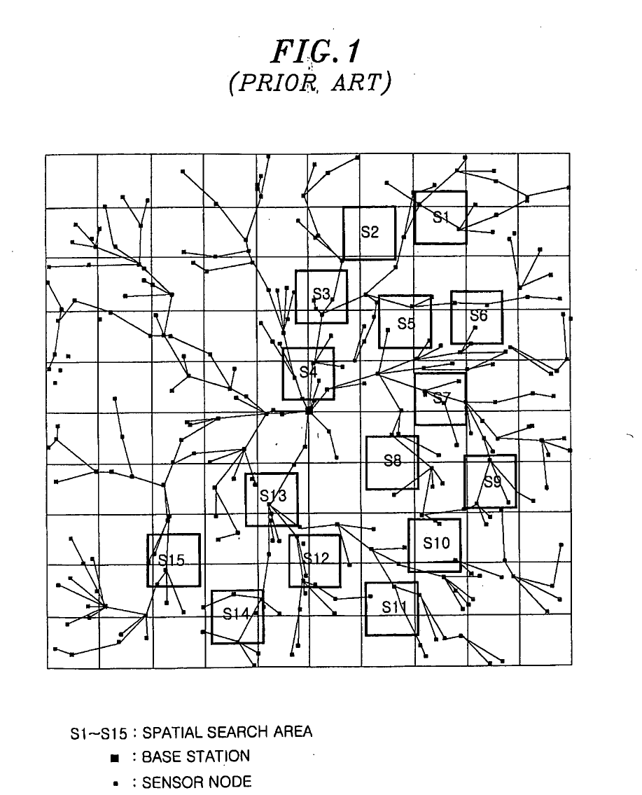

### DETAILED DESCRIPTION OF THE EMBODIMENTS

Hereinafter, embodiments of the present invention will be described in detail with reference to the accompanying drawings, which form a part hereof.

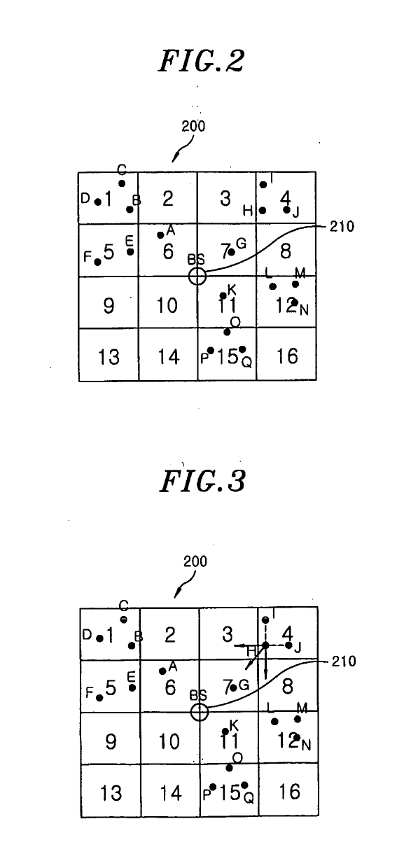

FIG. 2 illustrates an exemplary view for explaining method for creating a Grid-based tree in accordance with an embodiment of the present invention. An entire search area 200, in which sensor nodes A to Q are to be disposed, having a size of 100 m×100 m is divided into same-sized grids to form grid areas to which unique grid IDs are assigned.

When setting the size of each grid area, the number of sensor nodes in a search area and a size of the search area may be taken into consideration. Basically, a maximum communication distance of the sensor nodes is set as a size of a side of each grid area. In FIG. 2, since the size of the entire search area 200 is given as 100 m×100 m and the size of a side of each grid area is set as 25 m, the entire search area 200 is divided into sixteen grid areas, and grid IDs 1 to 16 are assigned to the grid areas, respectively.

A base station node (hereinafter, referred to as “BS node”) 210 in FIG. 2 transmits a wireless communication message to find sensor nodes with which the BS node 210 can establish connection, e.g., sensor nodes A, G and K, and registers thus found sensor nodes A, G and K as its candidate child nodes. Then, each of the sensor nodes A, G and K registers the BS node 210 as its candidate parent node. Such registration process, in which a node registers its candidate child nodes and each of the nodes registered as a candidate child node by the node register the node as its candidate parent node, is recursively performed from the BS node 210 to the last sensor node.

In other words, like the BS node 210 has done, each of the sensor nodes A, G and K having registered the BS node 210 as its candidate parent node transmits a wireless communication message to find sensor nodes with which each of the sensor nodes A, G and K can establish connection, and registers thus found sensor nodes as its candidate child nodes. Also, like the sensor nodes A, G and K have done, each of the candidate child nodes registered by at least one of the sensor node A, G and K registers at least one of the sensor node A, G and K as its candidate parent node.

In the above-described registration process, it should be noted that generation of a cycle between the candidate parent node and the candidate child node is required to be prevented. For example, the BS node 210 registered as a candidate parent node by the sensor node A cannot be registered as a candidate child node by the sensor node A. Accordingly, a sensor node having registered candidate parent nodes excludes the registered candidate parent nodes in finding its candidate child nodes.

For this, each sensor node obtains its level information before registering its candidate parent nodes and candidate child nodes. For example, if the BS node 210 in the search area 200 has a level of “0”, the sensor nodes A, G and K have levels of “1”. In this way, the level information for all sensor nodes in the entire search area 200 is set and stored in each sensor node.

Meanwhile, when registering candidate nodes, i.e., candidate child nodes and candidate parent nodes, each sensor node obtains a grid ID assigned to a grid area in which the sensor node resides by using its coordinate (location information). To be specific, each sensor node obtains the grid ID based on a grid size (a size of a side of each grid area), an entire search area size (a size of a side of the entire search area) and a coordinate of the sensor node. For example, if the grid size is 25, the entire search area size is 100 and the coordinate of the sensor node A is (35, 30), the grid ID is obtained by Equation 1:

grid ID=(round−up value of (Y-coordinate of a sensor node/Y-axis grid size))×(number of grids on each axis)+(round-off value of (X-coordinate of a sensor node/X-axis grid size)), Equation 1

wherein the number of grids on each axis is division of the entire search area size by the grid size. According to Equation 1, the number of grids on each axis becomes 100/25, i.e., four, and thus the grid ID of the sensor node A becomes 6 in this example.

Setting the candidate nodes, the level information and the grid ID is performed in each sensor node via a single wireless communication flooding process, and also via the flooding process, each sensor node including the BS node 210 becomes to have its candidate nodes and level information and grid IDs of its own and of its candidate nodes.

Thereafter, each sensor node other than the BS node 210 selects one of its candidate parent nodes as its parent node, by using the level information and the grid IDs. Further, the sensor node having selected its parent node becomes to be set as a child node in the selected parent node while being deleted in the rest of its candidate parent nodes.

Parent node selection begins with sensor nodes without having candidate child nodes. That is, the parent node selection begins with sensor nodes which had not registered candidate child nodes during the flooding process, or sensor nodes which have set as child nodes some or all of the candidate child nodes having registered during the flooding process and have deleted the rest of the candidate child nodes as described above.

In parent node selection, each sensor node searches for its candidate parent nodes residing in the same grid as the sensor node does and having a lower level than that of the sensor node, and then selects as its parent node a candidate parent node having the lowest level among the searched candidate parent nodes. If there are two or more candidate parent nodes having the lowest level, the sensor node determines its parent node based on distances between the candidate parent nodes and the BS node 210. The sensor node selects a candidate parent node having the smallest distance value as its parent node. Alternatively, the sensor node selecting its parent node calculates an MBR (Minimum Bounding Rectangle) surrounding all of the sensor node and child nodes and candidate parent nodes of the sensor node, and selects as its parent node a candidate parent node which minimizes an area of the MBR or a candidate parent node which minimizes a circumference of the MBR.

Meanwhile, if there is no candidate parent node within the same grid as that of the sensor node selecting its parent node, the sensor node finds candidate parent nodes within adjacent grid areas and selects its parent node through the above-described process, i.e., using the distance or the MBR.

For example, a sensor node H in FIG. 3 having sensor nodes G, L and M as its candidate parent nodes selects one of the candidate parent nodes G, L and M as its parent node. In other words, since all the candidate parent nodes G, L and M reside in different grid areas from the grid area in which the sensor node H resides, the sensor node H finds its parent node in its adjacent grid areas having grid IDs 3, 7 and 8. In FIG. 3, since only the sensor node G among the candidate parent nodes G, L and M resides in the adjacent grid areas of the sensor node H, the sensor node H selects the candidate parent node G in the grid area having the grid ID 7 as its parent node.

When a sensor node selects its parent node in its adjacent grid areas, a priority in searching for the adjacent grid areas may be used or not. When the priority is not used, the above-described MBRs or distances are calculated for all candidate parent nodes in the grid areas having the grid IDs 3, 7 and 8, and based thereon, the sensor node H selects one of the candidate parent nodes as its parent node, for example. When the priority in which a higher priority is assigned to a grid area closer to the BS node 210 is used, for example, searching for the grid area having the grid ID 7 is firstly carried out, and then searching for the grid areas having the grid IDs 3 and 8 are carried out.

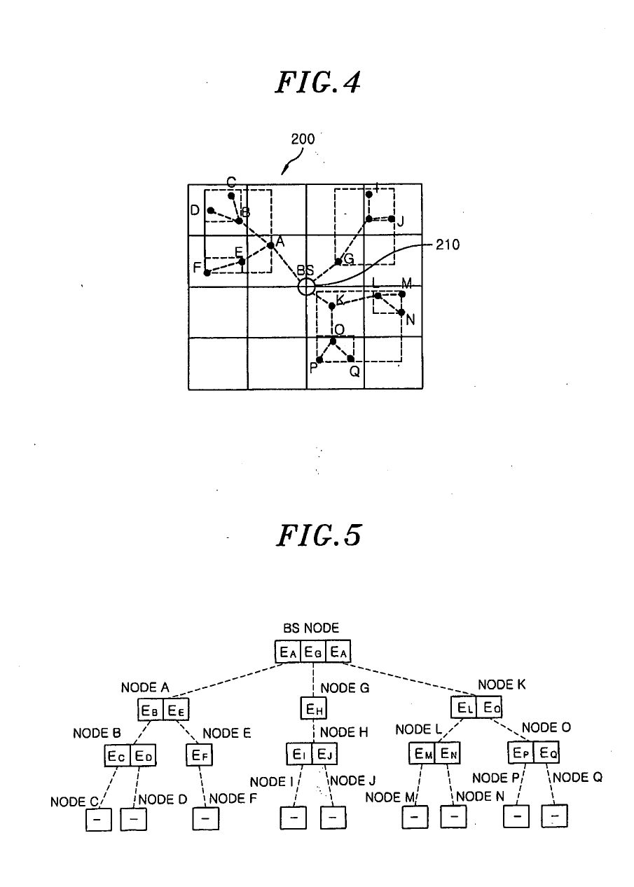

After the parent node selection, each sensor node needs to calculate and store, for each of its child nodes, an MBR surrounding the child node and all sensor nodes descended from the child node. For example, when a sensor node A has child nodes B and E, the sensor node B having child nodes C and D and the sensor node E having a child node F, as shown in FIG. 4, the sensor node A stores MBRs including the sensor nodes B, C and D and including the sensor nodes E and F, respectively.

The BS node 210 also stores an MBR including the sensor nodes A, B, C, D, E and F, an MBR including the sensor nodes G, H, I and J, and an MBR including the sensor nodes K, L, M, N, O, P and Q.

Through the above-described MBR calculation process, a Grid-based tree as shown in FIG. 5 can be created, in which each sensor node has entry information E including MBRs, grid IDs, level information, information on child nodes and parent nodes and the like.

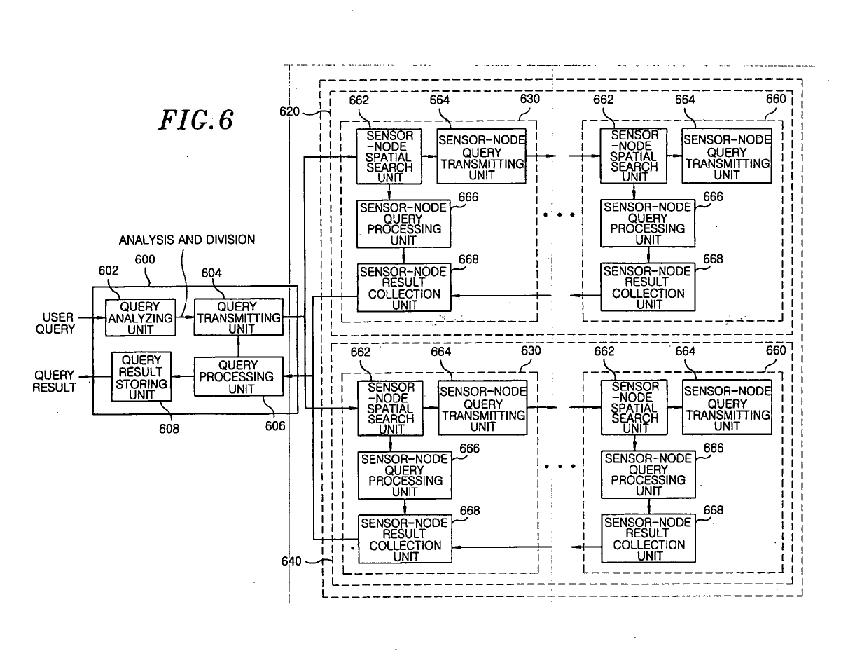

FIG. 6 illustrates a block diagram of a system for processing a complex spatial join query for two heterogeneous sensor networks using a Grid-based tree created according to the present invention. The system includes a server system 600 and sensor networks 620 and 640. Each of the sensor networks 620 and 640 includes a plurality of nodes, including a BS node 630 and a plurality of sensor nodes 660.

In the respective nodes of the sensor networks 620 and 640, grid-based entry information, e.g., MBRs, grid IDs, level information and information on child nodes and parent nodes, is stored.

The server system 600 includes a query analyzing unit 602, a query transmitting unit 604, a query processing unit 606 and a query result storing unit 608.

The query analyzing unit 602 analyzes a query input by a user to divide it into at least two queries, and then provides the resultant queries to the query transmitting unit 604. At this time, the query analyzing unit 602 divides the input query into a query relating to a spatial search and a query not relating to the spatial search.

The query transmitting unit 604 sequentially transmits the queries received from the query analyzing unit 602 to the sensor networks 620 and 640. For example, if query transmission order is to the sensor network 620 and then to the sensor network 640, the query transmitting unit 604 firstly transmits a query to the sensor network 620, and transmits a next query to the sensor network 640 after the query processing unit 606 receives result data of the query from the sensor network 620.

Here, the query transmitted to the sensor network 620 does not relate to a spatial search, while the query transmitted to the sensor network 640 is generated based on the result of the query transmitted to the sensor network 620 and relates to the spatial search.

The query processing unit 606 receives query result data from the respective sensor networks 620 and 640, and provides the query result data to the query result storing unit 608. Further, the query processing unit 606 controls, when receiving the result data from the sensor network 620, the query transmitting unit 604 to transmit the next query to the sensor network 640.

To be specific, when receiving from the sensor network 620 the result data corresponding to the query not relating to a spatial search, the query processing unit 606 changes spatial condition in a query relating to the spatial search into grid IDs and transmits the query having the changed spatial condition to the sensor network 640 via the query transmitting unit 604.

The query result storing unit 608 stores the result data received from the query processing unit 606 in a database and provides the result data to the user.

In each of the sensor networks 620 and 640, the BS node 630 and each of the sensor node 660 includes a sensor-node spatial search unit 662, a sensor-node query transmitting unit 664, a sensor-node query processing unit 666 and a sensor-node result collection unit 668.

The sensor-node spatial search unit 662 receives a query from the query transmitting unit 602 in the query server system 600 and performs a spatial search on the query. As for the spatial search, the sensor-node spatial search unit 662 calculates areas corresponding to the grid IDs contained in the query, and determines whether the node itself locates in the area to determine whether the node relates to the query or not. If it is determined that the node locates in the area, subsequent tasks of the spatial search are performed at the node, and otherwise, the node is excluded from the spatial search.

Further, the sensor-node spatial search unit 662 determines whether MBRs of child nodes of the node overlap with the grid areas given in the spatial search, and if so, transmits the query to the child nodes via the sensor-node query transmitting unit 664. The query transmitted to each of the child nodes does not contain all grid IDs contained in the query received from the server system 600, but only contains grid IDs of the grid areas overlapping with MBRs of the child node and attribute condition.

If the node locates in the area corresponding to the grid IDs in the query, the sensor-node query processing unit 666 obtains a sensed value corresponding to the query and determines whether the sensed value satisfies the attribute condition in the query. If the sensed value satisfies the attribute condition, the sensor-node query processing unit 664 transmits the query result data to the sensor-node result collection unit 666 to store the data therein.

Below, a user-input query processing procedure performed in the system configured as described above will be described.

For example, the sensor network 620 is for performing atmospheric monitoring and the sensor network 640 is for performing environmental monitoring.

First, the query analyzing unit 602 receives a query from a user, and analyzes the query to divide the query into transmission units for each sensor network. For example, if the user inputs an query, “Find sensor node pairs satisfying a condition of a carbon dioxide concentration above 10 PPM and a humidity above 60%, and obtain, among thus found sensor node pairs, carbon dioxide concentration, humidity information and an ID of the sensor node pair satisfying a condition of a distance within 10 m”, the query analyzing unit 602 divides the input query into two queries to be transmitted to the sensor networks 620 and 640, respectively. That is, the query analyzing unit 602 divides the input query into a first query, “Obtain IDs of sensor nodes satisfying a condition of a carbon dioxide concentration above 10 PPM, locations of the sensor nodes and carbon dioxide concentration values thereof”, and a second query, “Find, sensor node pairs distanced within 10 m among sensor nodes satisfying the first query, and obtain IDs of the sensor nodes satisfying a condition of humidity above 60%, locations of the sensor nodes and humidity information”. The first query is transmitted to the sensor network 620 via the query transmitting unit 604, and the second query is transmitted to the sensor network 640 via the query transmitting unit 604. Here, the first query does not relate to a spatial search and is transmitted to all sensor nodes 660 including the BS node 630 in the sensor network 620, while the second query relates to the spatial search and are transmitted to all sensor nodes 660 including the BS node 630 in the sensor network 640. Before the second query is transmitted, the spatial condition (within 10 m) in the second query is changed into grid IDs based on the result of the first query data.

Accordingly, sensor nodes satisfying the condition of the first query are found in the sensor network 620, and sensor nodes satisfying the condition of the second query are found in the sensor network 640. The result is provided to the query processing unit 606.

Meanwhile, the query transmitting unit 604 sequentially transmits the queries to the sensor networks 620 and 640 in cooperation with the query processing unit 606. That is, when the query processing unit 606 receives result data satisfying the condition of the first query, the query transmitting unit 604 changes the spatial condition in the second query into the grid IDs and then transmits the second query having the changed spatial condition to the sensor network 640 via the query transmitting unit 604.

In sequentially transmitting the first and second queries, the query transmitting unit 604 may give higher priority to a network having less sensor nodes in order to minimize the number of communication times generated in the overall sensor network. For example, if the sensor network 620 has 1,000 sensor nodes and the sensor network 640 has 10,000 sensor nodes, the first query is transmitted to all the nodes in the sensor network 620 having less number of sensor nodes, and then the second query is transmitted to only the nodes in the sensor network 640 satisfying the spatial condition by using Grid-based tree filtering based on the result of the first query.

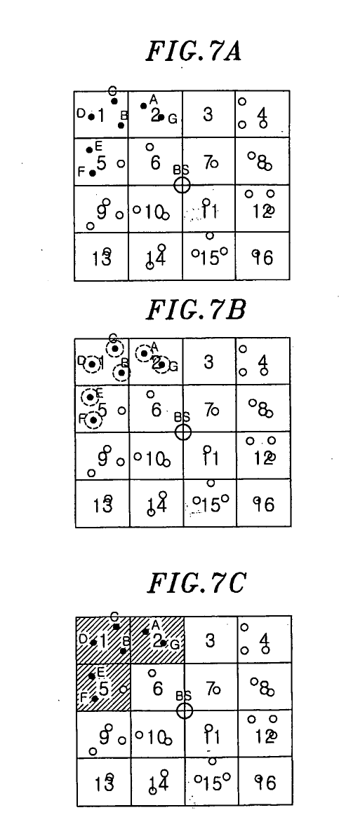

When receiving the result of the first query, the query processing unit 606 changes the second query efficiently in order to minimize the number of communication times occurring in the sensor network 640. For example, if sensor nodes A, B, C, D, E and F are given as the result of the first query as shown in FIG. 7A, the query processing unit 606 calculates areas corresponding to the spatial condition (within 10 m) of the second query with respect to the sensor nodes A, B, C, D, E and F as shown in FIG. 7B, and extracts grid IDs 1, 2 and 5 including the respective spatial condition areas as shown in FIG. 7C.

After that, the query processing unit 606 transmits the spatial condition changed into the extracted grid IDs and the attribute condition (humidity >60%) to the sensor network 640 via the query transmitting unit 604.

As such, all the spatial conditions are not transmitted, but instead, only the grid IDs are transmitted as shown in FIG. 7C, thereby reducing a query transmission packet size in wireless communications and reducing the number of spatial search times actually performed in the sensor network from seven to three.

In the sensor network 640, the sensor-node spatial search unit 662 of each of the BS node 630 and the sensor nodes 660 firstly performs the spatial search on the second query received from the query transmitting unit 604 to check if the node itself locates in the areas corresponding to the grid IDs. In other words, each of the BS node 630 and the sensor nodes 660 compares its grid ID to the grid IDs contained in the second query received from the query transmitting unit 604 to determine whether the node locates in the corresponding areas.

The node locating in the corresponding areas obtains a sensed value, i.e., a humidity value, by using the sensor-node query processing unit 666, and determines whether the humidity value satisfies the attribute condition (humidity >60%) of the second query and. If it is determined that the humidity value satisfies the attribute condition, the humidity value is stored in the sensor-node result collection unit 668.

Meanwhile, the node locating in the corresponding areas checks if the MBRs of the child nodes overlap with the areas corresponding to the grid IDs and, if so, the sensor-node query transmitting unit 664 transmits the second query to the child nodes. Here, the query transmitted to the child nodes contains grid IDs overlapping with the MBRs of the child nodes and the attribute condition.

Such query transmission process using the spatial search is repeatedly performed to sensor nodes without having child nodes. The sensor-node query processing unit 666 of each sensor nodes receiving the query processes the query to transmit a result satisfying the attribute condition to its parent node via the sensor-node result collection unit 668.

The result data collected by the sensor-node result collection unit 668 of the last parent node, i.e., the BS node 630, is transmitted to the query processing unit 606 of the server system 600.

Because filtering with an approximate grid-ID spatial condition as shown in FIG. 7C rather than with a real spatial condition is performed in the query processing procedure in the sensor network, the query processing unit 606 performs a refinement task on the query result data to find an exact result satisfying the real spatial condition.

The refined result data is combined with the result data of the sensor network 620 and transmitted to the query result storing unit 608, which stores the query result in a database (not shown) and provides to the user.

While the invention has been shown and described with respect to the embodiments, it will be understood by those skilled in the art that various changes and modification may be made without departing from the scope of the invention as defined in the following claims.

What is claimed is:

1. A method for creating a grid-based tree in a multiple sensor network, the method comprising:
dividing an entire search area in which a base station node and a plurality of sensor nodes are disposed into a specific number of grid areas;
assigning a grid ID to each of the grid areas;
setting, sequentially from the base station node to each of the sensor node, level information, candidate child nodes and candidate parent nodes, and storing the same in the respective nodes;
storing, in the respective nodes, a grid ID of a grid area in which the respective nodes locate;
selecting, for the respective sensor nodes, a parent node based on the grid ID, the level information, and the candidate parent nodes stored in respective sensor nodes;
calculating, for the respective nodes, minimum bounding rectangles each of which includes a child node of corresponding node and nodes descended from the child node, and storing the minimum bounding rectangles in the respective nodes; and
creating the grid-based tree by using the minimum bounding rectangles.

2. The method of claim 1, wherein a size of each of the grid areas is set according to at least one of the number of the sensor nodes, a size of the entire search area and a maximum communication distance of the respective sensor nodes.

3. The method of claim 1, wherein said setting the candidate parent nodes includes:
transmitting from a specific node a wireless communications message to find at least one sensor node with which the specific node can establish connection;
setting the found sensor node as a candidate child node of the specific node; and
storing in the candidate child node the specific node as a candidate parent node,
wherein the specific node does not set a sensor node, which has been stored as the candidate parent node of the specific node, as the candidate child node of the specific node.

4. The method of claim 1, wherein, in said storing the grid ID, the grid ID is calculated based on location information of the respective sensor nodes.

5. The method of claim 1, wherein said selecting the parent node includes:
determining whether at least one of the candidate parent nodes of the corresponding sensor node has the same grid ID as that of the corresponding sensor node; and
selecting, if it is determined that at least one of the candidate parent nodes has the same grid ID, one of the at least one of the candidate parent nodes as the parent node of the corresponding node.

6. The method of claim 5, wherein, if two or more of the candidate parent nodes have the same grid ID as that of the corresponding sensor node, one having the lowest level among the two or more of the candidate parent nodes is selected as the parent node.

7. The method of claim 6, wherein, if two or more of the candidate parent nodes having the lowest level, the parent node is selected based on a distance between each of the two or more of the candidate parent nodes having the lowest level and the base station node.

8. The method of claim 6, wherein, if two or more of the candidate parent nodes having the lowest level, a minimum bounding rectangle is calculated for each of the two or more of the candidate parent nodes and the parent node is selected based on the minimum bounding rectangles, each minimum bounding rectangle surrounding the corresponding sensor node, the child nodes of the corresponding sensor node and one of the two or more of the candidate parent nodes having the lowest level.

9. The method of claim 5, wherein, if it is determined that there is no candidate parent node having the same grid ID as that of the corresponding sensor node, the parent node is selected among the candidate parent nodes in adjacent grid areas.

10. The method of claim 9, wherein, if a priority of the adjacent grid areas is set, parent node selection in the adjacent grid areas is based on the priority.

11. A spatial query processing system in a multiple sensor network, wherein an entire search area of the network includes a plurality of sensor networks each having a plurality of nodes and is divided into grid areas having different grid IDs, the system comprising:
a query analyzing unit for analyzing an input query to divide the input query into queries to be transmitted to the respective sensor networks, the queries including a query relating to a spatial search and a query not relating to the spatial search;
a query processing unit for receiving a query result data of the query not relating to the spatial search and changing, based on the received query result data, a spatial condition in the query related to the spatial search; and
a query transmitting unit for transmitting to the respective sensor networks the query received from the query analyzing unit and the query changed by the query processing unit.

12. The system of claim 11, wherein the query transmitting unit assigns a priority to the respective sensor networks based on the number of sensor nodes in the respective sensor networks, and transmits the divided queries to corresponding networks according to the assigned priority.

13. The system of claim 11, wherein the query processing unit changes the spatial condition in the query relating to the spatial search into the grid IDs.

14. Sensor nodes in a multiple sensor network, wherein an entire search area including a plurality of sensor networks is divided into grid areas having different grid IDs, each of the sensor nodes comprising:
a spatial search unit for receiving a query containing grid IDs as a spatial condition and performing a spatial search based on the grid IDs;
a query processing unit for processing the query based on a spatial search result of the spatial search unit; and
a result collection unit for collecting result data of the query processing unit,
wherein the sensor nodes are connected in a Grid-based tree structure, and, each of the sensor nodes stores therein a grid ID of a grid in which the sensor node locates, level information of the sensor node, information on child nodes and a parent node of the sensor node and a minimum bounding rectangle for each of the child nodes, each minimum bounding rectangle including one of the child nodes and nodes descended from the child node.

15. The sensor nodes of claim 14, each of the sensor nodes further comprising:
a query transmitting unit for transmitting, if minimum bounding rectangles of the child nodes of the sensor node overlaps with the grid IDs corresponding to the spatial condition, to the child nodes a query containing a grid ID of the sensor node as the spatial condition.
